(19) United States
(12) Patent Application Publication
(10) Pub. No.: US 2026/0258938 A1
(43) Pub. Date: Sep. 3, 2026

(54) SEALED ASSEMBLY AND MANUFACTURING PROCESS

(71) Applicant: SIGNIFY HOLDING B.V., EINDHOVEN (NL)

(72) Inventors: Jean-François LAPORTE, Mascouche (CA); MICHEL FORTIN, QUEBEC (CA); EDGAR PEREZ, Boisbriand (CA); MARIA CAROLINA BONANCA, EINDHOVEN (NL)

(21) Appl. No.: 18/290,958

(22) PCT Filed: Jul. 13, 2022
(86) PCT No.: PCT/EP2022/069620

§ 371 Date: Jan. 22, 2024

Related U.S. Application Data
(60) Provisional application No. 63/226,398, filed on Jul. 28, 2021.

(30) Foreign Application Priority Data
Aug. 9, 2021 (EP) 21190262.2

(51) Int. Cl. F21V 31/00; F21V 3/02; F21V 3/06; F21V 17/12; F21V 29/70; F21W 131/10; F21Y 105/16; F21Y 115/10

(52) U.S. Cl. CPC F21V 31/005; F21V 3/02; F21V 3/0625; F21V 17/12; F21V 29/70; F21W 2131/10; F21Y 2105/16; F21Y 2115/10

(57) ABSTRACT

A light module (100) is disclosed including a housing (20) made at least in part from a thermally conductive material and includes an annular recess. A sealant (23) disposed in the annular recess and an optical plate (10) disposed in the housing (20). A portion (10a) of the optical plate (10) is disposed over the annular recess (21) and the sealant (23) forms a bond between the housing (20) and the portion (10a). An LED module (11) disposed between the housing (20) and the optical plate (10). At least some of the heat generated by the LED module 11 is conveyed to the housing (20) and dissipated. The light module (100) may also include a fastener (12) and the housing (20) may include a fastener stop (22). The fastener (12) is connected to the housing (20) and supports the optical plate (10). The fastener (12) is prevented from exerting excessive pressure on the optical plate (10) by the fastener stop (22).

### FIELD OF THE INVENTION

The invention relates to a sealed assembly and methods for manufacturing the sealed assembly, more particularly, to a sealed LED lighting module including an optical plate and housing/heat sink.

### BACKGROUND

Light emitting diode (LED) lighting devices can address many lighting application needs due to advantages such as energy saving, long service life, good applicability, short response time, and environmental protection. There are many LED lighting device applications which include, among others, roadway lighting, parking lot lighting as well as commercial and residential lighting. For these various lighting applications, different types of LED lighting units (i.e., LED-array bearing devices) must be used. Each lighting application may pose difficult problems such as the need for high luminance, reliability, durability as well as the need for water/air-tight enclosures and cost considerations. This is because the LED lighting units are susceptible to humidity, temperature and mechanical vibration that effect the service life.

In addition, dealing with heat dissipation requirements for high-luminance LED lighting units must be considered. Heat sinks are also often needed for electronic devices such as lighting units or luminaires. The lighting units generally include a light source, optics, control/driver circuitry, and a heat sink to help dissipate the heat generated by the light source. A heat sink is a passive heat exchanger that transfers the heat generated by the electronic or the mechanical device to allow the heat to be dissipated away from the device. This helps regulate the device's temperature.

Considering the above lighting applications and requirements, unique structures for mounting and heat dissipation may be needed. This may add to cost and complexity of the lighting units as well as the complications/cost in the manufacturing processes for such lighting units.

For example, there are conventional lighting units with exposed optical plates mounted on a heatsink that are manufactured with various assembly methods such as with gaskets, glue and mechanical fasteners. Such lighting units without protective lenses offer increased light output and an improved beam control, thus offering less expensive solutions. However, such optical plate assembly solutions that include gaskets and fasteners that can cause mechanical stresses on the optical plates and create long term cracks to appear and to compromise the seal around the optical plates.

As noted above, the sealing of the optical plate can be achieved by compression of components with mechanical fasteners. However, such assembly/mounting solutions may use clips that increase risk of failure of sealing. Also using mechanical fasteners such as a screw creates localized mechanical stresses on plastic components such as the optical plates. Furthermore, using multiple components adds cost and may increase the risk of sealing failure. Sealing with a gasket requires multiple fixation points (to prevent optical plate deformation) which is labor intensive and increases cost of manufacture.

This document describes devices and methods that are intended to address at least some issues discussed above and/or other issues as discussed below.

### SUMMARY OF THE INVENTION

Aspects and embodiments of the present invention address the issues noted above.

One aspect of the present invention is related to a sealed light module comprising a heat sink, liquid adhesive sealant, LED light source, optical plate, vent pad and fasteners with an assembly method to fix and seal the light module without applying pressure on optical plate. This will also reduce and/or optimize assembly time of the sealed light module.

Other aspects of the present invention include fabricating a heatsink (to which an optical plate can be attached) with a groove/channel to apply an adhesive sealant, and an incorporated assembly fastener stopper. The optical plate held in place using a mechanical fastener. The optical plate may be made from a plastic material. The groove and fastener stopper provide poke-yoke features in the assembly process by preventing excessive pressure (i.e., pressure that may damage the optical plate) from being excreted the optical plate which may damage the optical plate during the assembly process. In this regard, poke-yoke is a term that means “mistake-proofing” or “inadvertent error prevention”. A poka-yoke is any mechanism in a process that helps an equipment operator avoid mistakes/defects by preventing, correcting, or drawing attention to human errors as they occur.

One embodiment of the present invention is directed to a light module including a housing made at least in part from a thermally conductive material and includes an annular recess. A sealant is disposed in the annular recess and an optical plate is disposed in the housing. At least a portion of the optical plate is disposed over the annular recess and the sealant form a bond between the housing and the portion. An LED module is disposed between the housing and the optical plate. At least some of the heat generated by the LED module is conveyed to the housing and dissipated. The light module may also include a fastener and the housing may further includes a fastener stop. The fastener is connected to the housing and supports the optical plate. The fastener is prevented from exerting excessive pressure on the optical plate by the fastener stop.

In various embodiments, the light module is an LED light module and forms at least part of a housing for a luminaire. The luminaire may also include a mounting assembly that is connected to the LED light module to form a sealed enclosure against environmental hazards.

Another embodiment of the present invention is directed to a light module including a housing including a recess and a fastener stop. A sealant is disposed in the recess and a transparent panel made from a plastic material is disposed in the housing. At least a portion of the transparent panel is disposed over the recess and the sealant form a bond between the housing and the portion. A fastener is connected to the housing that supports the transparent panel and is prevented from exerting excessive pressure on the transparent panel by the fastener stop.

In one embodiment of the present invention the fastener is a screw and the fastener stop is a protrusion on the housing that prevents the fastener from being inserted below a predetermined position.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 shows rendering of a light module according to one embodiment of the present invention,

FIG. 2 shows various unassembled components of the light module of FIG. 1,

FIG. 3 shows a cross section rendering of the assembled light module of FIG. 1,

FIGS. 4A and 4B show a more detailed cross section rendering of the light module of FIG. 1, and

FIG. 5 shows a luminaire according to various aspects of the present invention.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

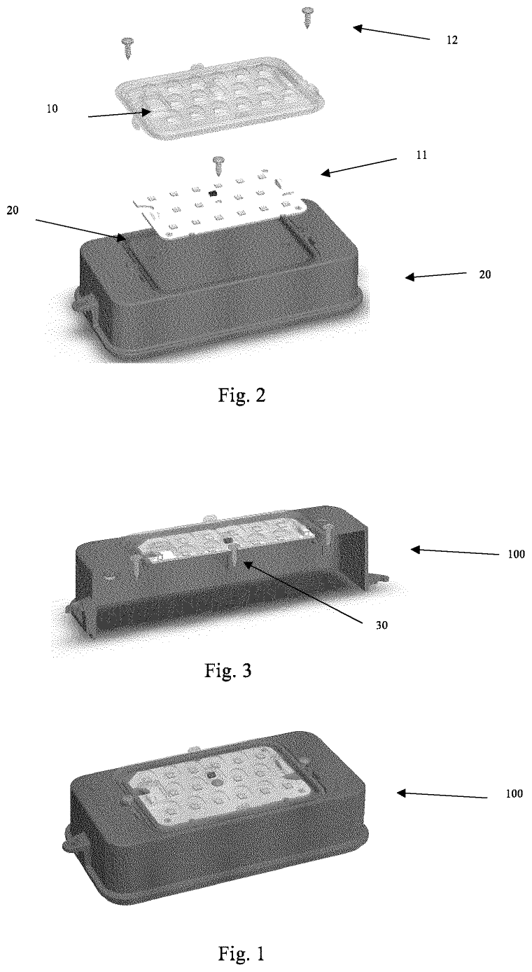

FIG. 1 shows an example of a light module 100 according to one embodiment of the present invention. It should be understood the light module 100 may be manufactured in various shapes and sizes. The configuration of the light module 100 may be designed to fit various lighting applications.

FIG. 2 shows various unassembled components of the light module 100. The light module 100 includes an optical plate (or panel) 10, an LED module 11 (i.e., an LED-based light source), a housing 20 and one or more fasteners 12.

The terms “controller” or “module” are used herein generally to describe a structure or circuitry that can be implemented in numerous ways (e.g., such as with dedicated hardware and/or software) to perform various functions discussed herein. A “processor” is one example of a controller (or a central component of a controller) which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

The optical plate 10 may have one or more of the following functions. Guide the light source of the LED module 11 so that the light is evenly distributed throughout the surface of the optical plate 10 (some optical plates can control the exit angle in addition to making the light uniform). Support the LED module 11 to protect the underlying materials from damage. The optical plate 10 may also use a reflection mechanism to more efficiently use the luminous flux and control the light distribution. The optical plate 10 may be made from a transparent plastic material such as a polycarbonate or acrylic sheet. Such materials are widely used because of their high light transmittance and strong impact resistance. For example, transparent acrylic sheets may be anti-oxidized and have more than 92% transmittance.

The LED module 11 (or LED array) is an assembly of LED packages (components), or dies (or chips) on a printed circuit board or substrate, oftentimes with optical elements whereby light generated by the LED can have a desired pattern of distribution. The LED module is usually a plastic or ceramic material having thermal management, mechanical support, and electrical interfaces to couple to the load side of a current source ton LED driver/controller. The LED module may be in any shape or size to fit the lighting application needs.

The term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The housing 20 may be used in part as a heatsink. The housing 20 may be made whole or in part of a thermally conductive material, for example, from an aluminum sheet metal plate. Suitable materials for the housing 20 include one or more of aluminum alloys 1051, 6061, 6063, copper, copper-tungsten, magnesium, silver and combinations of two or more of the afore mentioned. However, other thermal conductive materials may also be applied. The term “thermally conductive” refers to a material having a thermal conductivity of at least 5 W/(m K), such as at least 10 W/(m K), especially at least 100 W/(m K). Examples of suitable materials include steel, aluminum, copper, AlN, BN, SiC, and AL6061.

The heat generated by the LED module 11 and/or other components that generate heat can be conveyed to the housing 20 and then be dissipated to the outside, so that the light module 100 has no need of a cooling fin for heat dissipation. This embodiment allows the housing 20 to serve more than one purpose and eliminates additional components that may be needed for a heatsink. This saves cost and time in assembly of the light module 100.

FIG. 2 shows an example of one configuration of the housing 20. In this embodiment, the housing 20 is rectangular. It should be understood that other geometric shapes may be used to accommodate lighting application needs. For example, the housing 20 may also comprise a circular, rectangular, pentagonal, hexagonal, elliptical, or octagonal cross-section, or overall shape. Hence, in various embodiments, the housing 20 has a cross-section selected from the group consisting of circular, elliptical, triangular, square, rectangular, pentagonal, hexagonal, and octagonal. The housing 20 may consist all, or in part, of one or more thermally conductive materials discussed above.

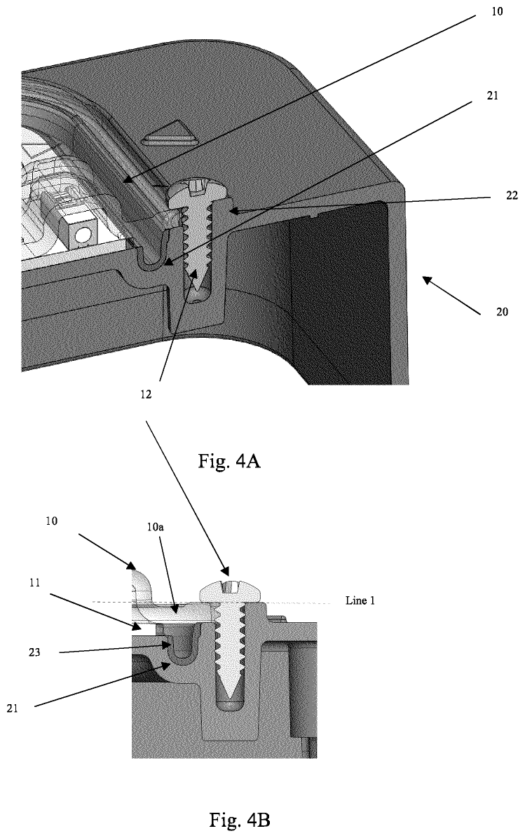

The housing 20 includes a recess 21 that may be partially or fully filled with a sealant 23 (shown in FIG. 4B). In a preferred embodiment, the recess 21 forms a closed loop (e.g., annular) in the housing 20. In other embodiments, there may be one or more of recesses 21 that are not fully connected to form a closed loop. In the embodiment of FIG. 2, the closed loop generally has a rectangular shape with rounded corners, however other shapes may be used to accommodate assembly of the LED module 11 in the housing 20. As shown in FIGS. 4A and 4B, the recess 21 has a half circular shape. However, the recess 21 may have other cross-section shapes such as elliptical, triangular, square, rectangular, pentagonal, hexagonal, and octagonal. However, the exact location of the recess 21 will depend on the configuration, shape and/or orientation of the optical plate 10 and LED module 11 required to for the lighting application. For example, the recess 21 may be located on the periphery of the housing 20 to encircle the LED module 11 (when assembled) and allow the optical plate 10 to cover the LED module 11 as described below.

The fastener 12 is a mechanical device that is used to join or hold at least the optical plate 10 to the housing 20. This may be a permanent or non-permanent joint. As shown in FIG. 2, the fastener 12 is a screw. Other types of fasteners 12 include bolts, nuts, washers, cotter joint, rivets, inserts, and snap rings.

The housing 20 also includes a fastener stop 22. The fastener stop 22 reduces and/or prevents excessive pressure from being exerted on the optical plate 10 when the fastener 12 is used to assemble/hold the optical plate 10 to the housing 20 over the LED module 11. As shown in FIG. 4B, the fastener stop 22 is a raised protrusion that prevents the fastener 21 to be inserted below a fixed depth/location. In this embodiment, the raised protrusion is approximately at the same height as at least a portion 10a of the optical plate 10 when assembled in the housing 20 (see Line 1 in FIG. 4B). In this regard, the optical plate 10 may include a central region that covers the LED module 11 and the portion 10a that is deposed over the recess 21. The central region and the portion 10a may have varying heights as measured from the top of the LED module 11. The fastener stop 22 prevents some or all pressure from the fastener 21 to be exerted on the optical plate 10. As shown in FIG. 4B, the portion 10a of the optical plate 10 is disposed above the recess 21 and rests at least partially on the housing 20 when assembled in the housing 20. The portion 10a of the optical plate 10 may also be used to hold/support the LED module 11 in place within the housing 20.

During the assembly process, the sealant 23 is disposed in the recess 21. When cured, the sealant 23 provides a seal between the optical plate 10 and the housing 20. The seal may be airtight and waterproof. The sealant 23 is applied in a liquid or tacky state which undergoes a curing process to create a hold between the two surfaces. The sealant 23 may be, for example, a silicone adhesive, a two-part plastic adhesive or epoxy, or a liquid adhesive sealant. The most common liquid adhesive sealants are acrylics usually containing hydroxyl and amine groups although polymethylmethacrylate (PMMA).

FIG. 3 shows a cross section rendering of the assembled light module 100 that shows the placement of the optical plate 10, the LED module 11, the housing 20 and the fasteners 12. The LED module 11 is disposed in the housing 20 and the optical plate 10 completely covers the LED module 11. It is noted that in the FIG. 3 (as well as in FIGS. 1 and 2) that a screw 30 is shown. The screw 30 is below the optical plate 10 and does not support the optical plate 10. The screw 30 (or other type of fastener) is optional and may be used to support the LED module 11 in the housing 20.

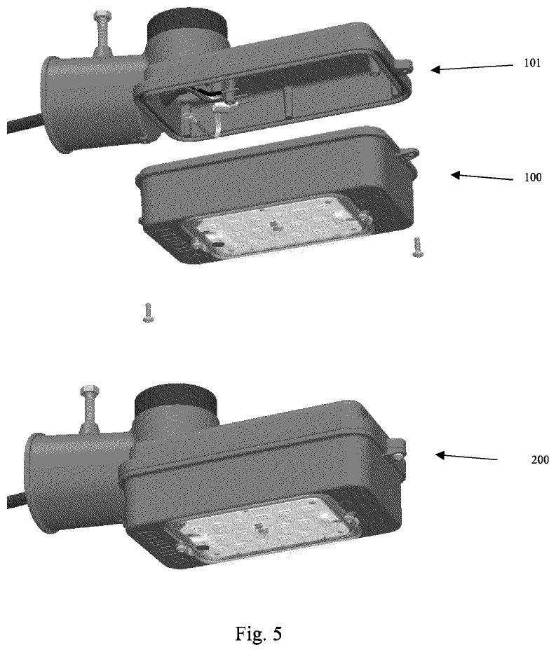

FIG. 5 shows a luminaire 200 including the light module 100 and a mounting assembly 101 according to various aspects of the present invention. In this embodiment, the luminaire 200 is a LED-based lighting unit using the light module 100. The light module 100 is physically and electrically coupled to the mounting assembly 101. The luminaire 200 may also include other elements (not shown) such a controller or light driver unit, and a power supply or power supply connections to supply necessary power to the light module 100. It should also be understood that the light module 100 and the mounting assembly 101 by a single integrated unit.

The term “luminaire” or “lighting unit” used here refers to an implementation or arrangement of one or more lighting units in a particular form factor, assembly, or package. A given lighting unit may have any one of a variety of mounting arrangements, enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources.

The luminaire 200 may be designed for outdoor lighting applications. In this regard, the luminaire 200 may be IP rated. The IP rating system is used across the world to rate enclosures on the level of protection provided against environmental hazards. IP rated enclosures provide dust protection and water protection. Various parts of the luminaire 200 may be made from stainless steel, carbon steel, aluminum and/or polycarbonate.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. For example, the housing 20 is not limited to a structure for luminaires.

More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

In the claims references in parentheses refer to reference signs in drawings of exemplifying embodiments or to formulas of embodiments, thus increasing the intelligibility of the claim. These references shall not be construed as limiting the claim.

1. A light module comprising:
a housing including a recess and a fastener stop;
a liquid or tacky state sealant disposed in the recess;
a transparent panel made from a plastic material disposed in the housing, wherein at least a portion of the transparent panel is disposed over the recess and the sealant form a bond, when the liquid or tacky state sealant cures, between the housing and the portion; and
a fastener connected to the housing that supports the transparent panel and is prevented from exerting excessive pressure on the transparent panel by the fastener stop, wherein the fastener stop is a raised protrusion that prevents the fastener to be inserted below a fixed depth/location, wherein the raised protrusion is the same height as at least a portion of the optical plate.

2. The light module of claim 1, wherein the fastener is a screw and the fastener stop is a protrusion on the housing that prevents the fastener from being inserted below a predetermined position.

3. The light module of claim 1, wherein the recess is annular and has a cross-section selected from the group consisting of circular, elliptical, triangular, square, rectangular, pentagonal, hexagonal, or octagonal.

4. The light module of claim 3, wherein the bond is waterproof.

5. The light module of claim 4 further comprising an LED module disposed between the housing and the transparent panel wherein the housing functions at least in part as a heatsink and the transparent panel is an optical plate.

6. The light module of claim 5, wherein the sealant is a liquid adhesive sealant.

7. The light module of claim 1, wherein the light module forms at least part of a housing for a luminaire.

8. A luminaire comprising the light module of claim 1 and a mounting assembly, wherein the light module and the mounting assembly are connected to form a sealed enclosure against environmental hazards.

9. The light module of claim 1, wherein the housing made at least in part from a thermally conductive material and the recess is an annular recess, wherein the transparent panel an optical plate; and an LED module disposed between the housing and the optical plate, and wherein at least some of the heat generated by the LED module 11 is conveyed to the housing and dissipated.

10. The light module of claim 9, further comprising a fastener and the housing further includes a fastener stop, wherein the fastener is connected to the housing and supports the optical plate and the fastener is prevented from exerting excessive pressure on the optical plate by the fastener stop.

11. The light module of claim 10, wherein the fastener is a screw and the fastener stop is a protrusion on the housing that prevents the fastener from being inserted below a predetermined position.

12. The light module of claim 11, wherein the annular recess has at least a partial cross-section selected from the group consisting of circular, elliptical, triangular, square, rectangular, pentagonal, hexagonal, or octagonal.

13. The light module of claim 9, wherein the bond is waterproof.

14. The light module of claim 9, wherein the light module forms at least part of a housing for a luminaire.

15. A luminaire comprising the light module of claim 1 and a mounting assembly, wherein the light module and the mounting assembly are connected to form a sealed enclosure against environmental hazards.
